(19) United States
(12) Patent Application Publication
(10) Pub. No.: US 2024/0204639 A1
(43) Pub. Date: Jun. 20, 2024

(54) VIBRATION MOTOR

(71) Applicant: AAC Microtech (Changzhou) Co., Ltd., Changzhou (CN)

(72) Inventors: Lubin Mao, Changzhou (CN); Yun Tang, Changzhou (CN); Jie Ma, Changzhou (CN)

(21) Appl. No.: 18/322,619

(22) Filed: May 24, 2023

Related U.S. Application Data
(63) Continuation of application No. PCT/CN2022/139861, filed on Dec. 19, 2022.

(51) Int. Cl. H02K 33/02

(52) U.S. Cl. CPC H02K 33/02

(57) ABSTRACT

A vibration motor, including a vibration assembly and a stator assembly. The vibration assembly includes a weight, a magnet assembly fixed to an inner wall of the weight, and an elastic member. The magnet assembly includes a first magnet assembly fixed to the inner wall along a first direction perpendicular to a vibrating direction. The first magnet assembly includes a first magnetically conductive plate fixed to the inner wall and a first magnet fixed to a side of the first magnetically conductive plate away from the inner wall. The magnet assembly includes a second magnet between the inner wall and the first magnetically-conductive plate. The first magnetically-conductive plate is provided with the first and second magnets at two sides, effectively improving magnetic field performance and significantly improving a driving force. The vibration motor provides users with strong vibration feedback, improving user experience.

### TECHNICAL FIELD

The present disclosure relates to the technical field of motors, and in particular, to a vibration motor applied to portable mobile terminals.

### BACKGROUND

With the development of electronic technologies, portable consumer electronic products are becoming more and more popular, such as mobile phones, handheld game consoles, navigation apparatuses, or handheld multimedia entertainment devices. In these electronic products, vibration motors may generally be used for system feedback, such as mobile phone call prompts, information prompts, navigation prompts, and vibration feedback of game consoles. Such a wide range of applications requires excellent performance and a long service life of the vibration motors.

A vibration motor in the related art includes a housing having a receiving space, a vibration assembly located in the receiving space, and a stator assembly fixed to the housing. The vibration assembly generally includes a weight and a magnet fixed to the weight. The stator assembly includes a coil interacting with the magnet to provide a driving force. However, in the related art, the magnet at a side of the coil is generally provided only with a single magnet, resulting in a limited driving force. When the vibration motor is required to provide strong vibration feedback, such a magnet structure cannot meet the requirement.

Therefore, there is a need to provide a new vibration motor to solve the above technical problems.

### SUMMARY

In an aspect, the present disclosure provides a vibration motor, including a housing having a receiving space, and a vibration assembly and a stator assembly that are received in the receiving space. The vibration assembly includes a weight arranged apart from the housing, a magnet assembly fixed to the weight, and an elastic member supporting the weight in the receiving space, the weight is provided with a receiving hole running therethrough, the weight includes an inner wall enclosing to form the receiving hole, the magnet assembly is received in the receiving hole and fixed to the inner wall; the stator assembly includes a coil assembly fixed to the housing, partially received in the receiving hole, and arranged opposite to the magnet assembly. The magnet assembly includes a first magnet assembly fixed to the inner wall along a first direction perpendicular to a vibrating direction, the first magnet assembly includes a first magnetically conductive plate fixed to the inner wall and a first magnet fixed to a side of the first magnetically conductive plate away from the inner wall, and the magnet assembly further includes a second magnet sandwiched between the inner wall and the first magnetically conductive plate.

As an improvement, the magnet assembly further includes a second magnet assembly fixed to the inner wall along the vibrating direction, and the second magnet assembly includes a second magnetically conductive plate fixed to the inner wall, and a third magnet fixed to a side of the second magnetically conductive plate away from the inner wall.

As an improvement, the second magnet assembly further includes a fourth magnet sandwiched between the second magnetically conductive plate and the inner wall.

As an improvement, the second magnet, the first magnetically conductive plate, and the first magnet are sequentially stacked on the inner wall along the first direction, and projections of the second magnet, the first magnetically conductive plate, and the first magnet along the first direction completely overlap.

As an improvement, the first magnet is a three-segment magnetization structure, the first magnet has a first magnetization region, a second magnetization region, and a third magnetization region sequentially arranged along the vibrating direction; and the first magnetization region and the third magnetization region have a same magnetization direction, and are both magnetized along a direction perpendicular to the vibrating direction.

As an improvement, the first magnet is a three-segment magnetization structure, the first magnet has a first magnetization region, a second magnetization region, and a third magnetization region sequentially arranged along the vibrating direction; and the first magnetization region and the third magnetization region have opposite magnetization directions and are both magnetized along the vibrating direction.

As an improvement, the magnet assembly includes two first magnet assemblies, the two first magnet assemblies are respectively arranged at two sides of the coil assembly along the first direction, and the first magnets of the two first magnet assemblies have poles of a same polarity opposite to each other.

As an improvement, projections of the third magnet, the second magnetically conductive plate, and the fourth magnet along the vibrating direction completely overlap.

As an improvement, the third magnet and the fourth magnet have a same magnetization direction, and are both magnetized along the vibrating direction.

As an improvement, the magnet assembly includes two second magnet assemblies, the two second magnet assemblies are respectively arranged at two sides of the coil assembly along the vibrating direction, and the third magnets of the two second magnet assemblies have poles of a same polarity opposite to each other.

### BRIEF DESCRIPTION OF DRAWINGS

In order to better illustrate the technical solutions in the embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a three-dimensional view of a vibration motor according to an embodiment of the present disclosure;

FIG. 2 is an exploded view of the vibration motor according to an embodiment of the present disclosure;

FIG. 3 is a three-dimensional view of a partial structure of the vibration motor according to an embodiment of the present disclosure;

FIG. 4 is a schematic diagram of a magnetization direction of a magnet assembly of the vibration motor in FIG. 3;

FIG. 5 is a three-dimensional view of a partial structure of the vibration motor according to another embodiment of the present disclosure;

FIG. 6 is a schematic diagram of a magnetization direction of a magnet assembly of the vibration motor in FIG. 5;

FIG. 7 is a schematic diagram of a magnetization direction of a magnet assembly of the vibration motor in FIG. 5;

FIG. 8 is a schematic diagram of a magnetization direction of a magnet assembly of the vibration motor in FIG. 5;

FIG. 9 is a three-dimensional view of a partial structure of the vibration motor according to another embodiment of the present disclosure; and

FIG. 10 is a schematic diagram of a magnetization direction of a magnet assembly of the vibration motor in FIG. 9.

### DESCRIPTION OF EMBODIMENTS

The technical solution in embodiments of the present disclosure is clearly and completely described below with reference to the accompanying drawings in the embodiments of the present disclosure.

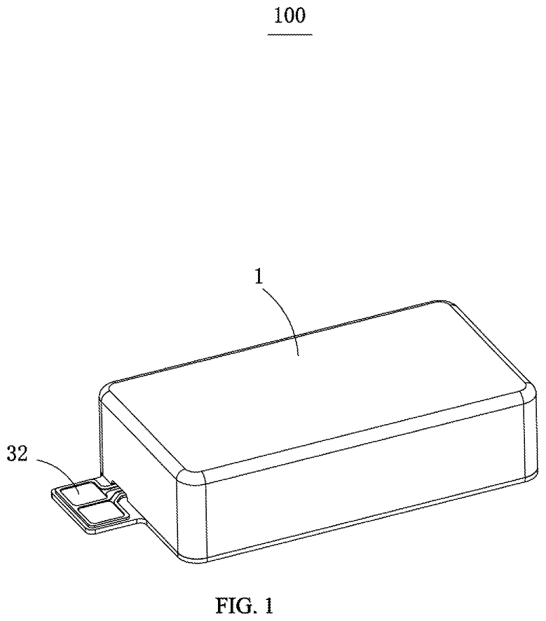

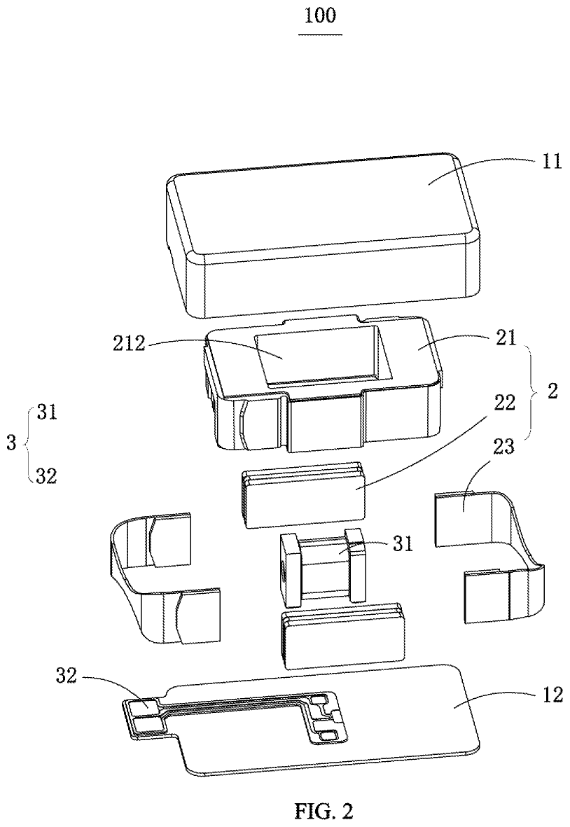

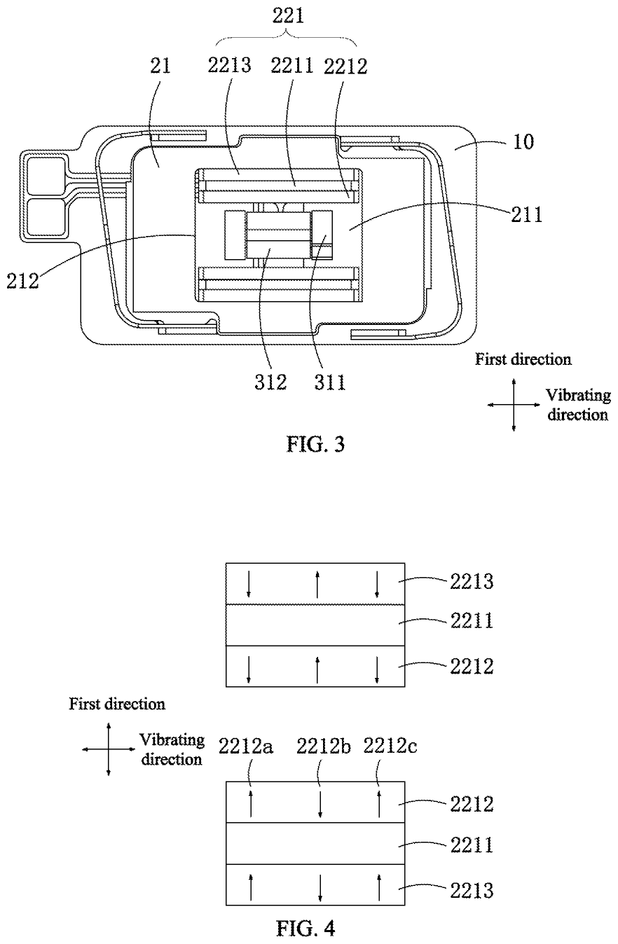

As shown in FIG. 1 to FIG. 4, an embodiment of the present disclosure provides a vibration motor 100, including a housing 1 having a receiving space 10, and a vibration assembly 2 and a stator assembly 3 that are received in the receiving space 10.

The housing 1 includes an upper housing 11 having the receiving space 10, and a lower cover 12 fixed to the upper housing 11. The lower cover 12 and the upper housing 11 enclose to form the receiving space 10.

The vibration assembly 2 includes a weight 21 arranged apart from the housing 1, a magnet assembly 22 fixed to the weight 21, and an elastic member 23 supporting the weight 21 in the receiving space 10. In an example, the elastic member 23 is fixed to the upper housing 11. The weight 21 is provided with a receiving hole 211 running therethrough, and the weight 21 includes an inner wall 212 enclosing to form the receiving hole 211. The magnet assembly 22 is received in the receiving hole 211 and fixed to the inner wall 212.

The stator assembly 3 includes a coil assembly 31 fixed to the housing 1, partially received in the receiving hole 211, and arranged opposite to the magnet assembly 22. The stator assembly 3 further includes a flexible printed circuit board 32 electrically connecting the coil assembly 31 with an external circuit. In an example, the coil assembly 31 includes an iron core 311 fixed to the housing 1, and a coil 312 wound around the iron core 311. The coil 312 is electrically connected to the flexible printed circuit board 32. In an example, both the iron core 311 and the flexible printed circuit board 32 are fixed to the lower cover 12. The coil 312 is received in the receiving hole 211 and arranged opposite to the magnet assembly 22. When the coil 312 is energized, the coil 312 interacts with the magnet assembly 22 to generate a driving force to enable the elastic member 23 to drive the weight 21 and the magnet assembly 22 to move along a vibrating direction, so as to provide vibration feedback.

As shown in FIG. 1 to FIG. 3, the magnet assembly 22 includes a first magnet assembly 221 fixed to the inner wall 212 along a first direction perpendicular to the vibrating direction, and the first magnet assembly 221 includes a first magnetically conductive plate 2211 fixed to the inner wall 212 and a first magnet 2212 fixed to a side of the first magnetically conductive plate 2211 away from the inner wall 212. In order to improve magnetic field performance of the magnet assembly 22, in the vibration motor 100 of the present disclosure, the magnet assembly 22 further includes a second magnet 2213 sandwiched between the inner wall 212 and the first magnetically conductive plate 2211. The second magnet 2213, the first magnetically conductive plate 2211, and the first magnet 2212 are sequentially stacked on the inner wall 212 along the first direction, and projections of the second magnet 2213, the first magnetically conductive plate 2211, and the first magnet 2212 along the first direction completely overlap.

In this embodiment, as shown in FIG. 4, the first magnet 2212 is a three-segment magnetization structure, the first magnet 2212 has a first magnetization region 2212a, a second magnetization region 2212b, and a third magnetization region 2212c sequentially arranged along the vibrating direction. The first magnetization region 2212a and the third magnetization region 2212c have a same magnetization direction, and are both magnetized along a first direction perpendicular to the vibrating direction. A magnetization direction of the second magnetization region 2212b is opposite to that of the first magnetization region 2212a. In this embodiment, magnetization structures of the first magnet 2212 and the second magnet 2213 are completely the same. That is, the second magnet 2213 is also a three-segment magnetization structure, and a magnetization direction of each segment is the same as that of the first magnet 2212. It can be understood that the magnet assembly 22 includes two first magnet assemblies 221, the two first magnet assemblies 221 are respectively arranged at two sides of the coil assembly 31 along the first direction, and the first magnets 2212 of the two first magnet assemblies 221 have poles of a same polarity opposite to each other.

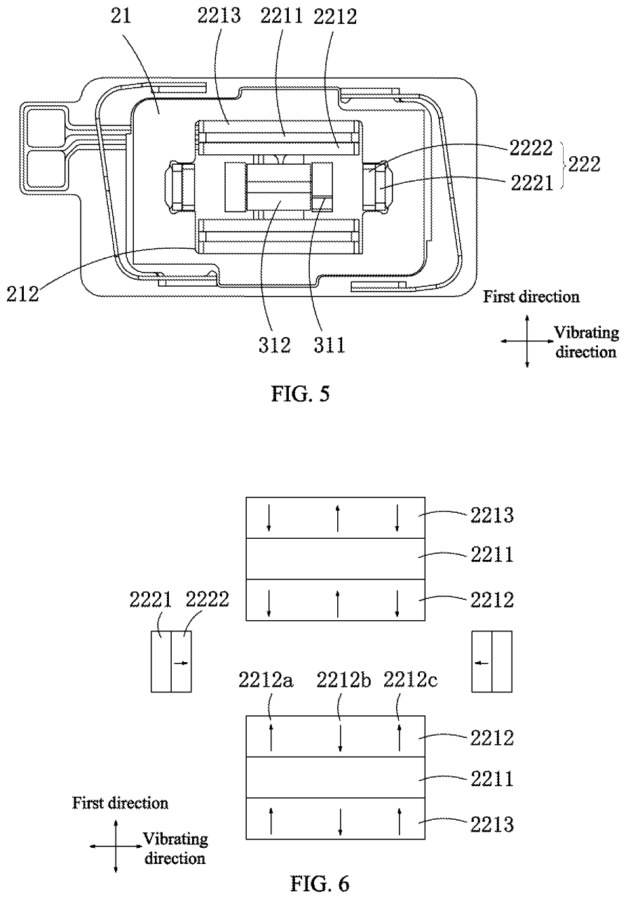

In the vibration motor according to another embodiment of the present disclosure, in order to further enhance the magnetic field performance of the magnet assembly 22, as shown in FIG. 5, the magnet assembly 22 further includes a second magnet assembly 222 fixed to the inner wall 212 along the vibrating direction, and the second magnet assembly 222 includes a second magnetically conductive plate 2221 fixed to the inner wall 212 and a third magnet 2222 fixed to a side of the second magnetically conductive plate 2221 away from the inner wall 212. In this embodiment, as shown in FIG. 6, the third magnet 2222 is magnetized along the vibrating direction. Similarly, the magnet assembly 22 includes two second magnet assemblies 222, and the two second magnet assemblies 222 are respectively arranged at two sides of the coil assembly 31 along the vibrating direction. The second magnets 2222 of the two second magnet assemblies 222 have poles of a same polarity opposite to each other.

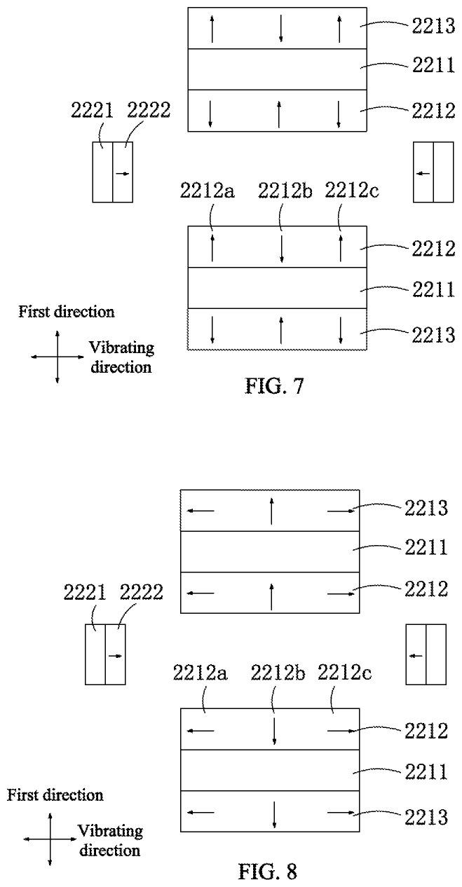

Further, a magnetization direction of the first magnet assembly 221 may be designed according to different structures. As shown in FIG. 7, the only difference from FIG. 6 is that magnetization directions of the first magnet 2212 and the second magnet 2213 are opposite. In addition, FIG. 8 shows another magnetization manner of the first magnet assembly 221. That is, the first magnetization region 2212a and the third magnetization region 2212c may have opposite magnetization directions and are both magnetized along the vibrating direction. In this case, the second magnetization region 2212b is still magnetized along the first direction. That is, the magnetization direction of the second magnetization region 2212b is perpendicular to that of the first magnetization region 2212a. The above merely shows some possible magnetization of the magnet assembly 22, which can be designed according to actual requirements.

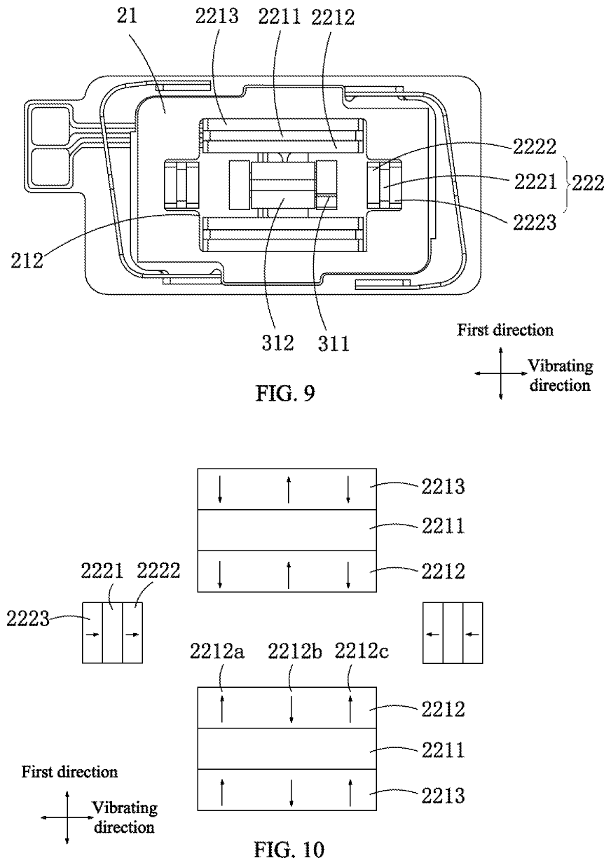

Further, as shown in FIG. 9 and FIG. 10, in the vibration motor according to yet another embodiment of the present disclosure, the only difference from the vibration motor in FIG. 5 is that the second magnet assembly 222 further includes a fourth magnet 2223 sandwiched between the second magnetically conductive plate 2221 and the inner wall 212. In an example, projections of the third magnet 2222, the second magnetically conductive plate 2221, and the fourth magnet 2223 along the vibrating direction completely overlap. The fourth magnet 2223 and the third magnet 2222 have a same magnetization direction, and are both magnetized along the vibrating direction.

Compared with the related art, the vibration motor according to the present disclosure includes a vibration assembly and a stator assembly. The vibration assembly includes a weight, a magnet assembly fixed to the weight, and an elastic member supporting the weight. The weight is provided with a receiving hole running therethrough, and the weight includes an inner wall enclosing to form the receiving hole. The magnet assembly includes a first magnet assembly fixed to the inner wall along a first direction perpendicular to a vibrating direction. The first magnet assembly includes a first magnetically conductive plate fixed to the inner wall and a first magnet fixed to a side of the first magnetically conductive plate away from the inner wall. The magnet assembly further includes a second magnet sandwiched between the inner wall and the first magnetically conductive plate. The first magnetically conductive plate is provided with the first magnet at one side and the second magnet oat another side, thereby effectively improving magnetic field performance of the magnet assembly and significantly improving a driving force of the vibration motor. Therefore, the vibration motor can provide users with strong vibration feedback, thereby improving user experience.

The above descriptions are merely some embodiments of the present disclosure. It should be pointed out herein that, for those of ordinary skill in the art, improvements can also be made without departing from the creative concept of the present disclosure, all of which shall fall within a scope of the present disclosure.

What is claimed is:

1. A vibration motor, comprising a housing having a receiving space, and a vibration assembly and a stator assembly that are received in the receiving space;
wherein the vibration assembly comprises a weight arranged apart from the housing, a magnet assembly fixed to the weight, and an elastic member supporting the weight in the receiving space, the weight is provided with a receiving hole running therethrough, the weight comprises an inner wall enclosing to form the receiving hole, the magnet assembly is received in the receiving hole and fixed to the inner wall; the stator assembly comprises a coil assembly fixed to the housing, partially received in the receiving hole, and arranged opposite to the magnet assembly, wherein the magnet assembly comprises a first magnet assembly fixed to the inner wall along a first direction perpendicular to a vibrating direction, the first magnet assembly comprises a first magnetically conductive plate fixed to the inner wall and a first magnet fixed to a side of the first magnetically conductive plate away from the inner wall, and the magnet assembly further comprises a second magnet sandwiched between the inner wall and the first magnetically conductive plate.

2. The vibration motor as described in claim 1, wherein the magnet assembly further comprises a second magnet assembly fixed to the inner wall along the vibrating direction, and the second magnet assembly comprises a second magnetically conductive plate fixed to the inner wall, and a third magnet fixed to a side of the second magnetically conductive plate away from the inner wall.

3. The vibration motor as described in claim 2, wherein the second magnet assembly further comprises a fourth magnet sandwiched between the second magnetically conductive plate and the inner wall.

4. The vibration motor as described in claim 1, wherein the second magnet, the first magnetically conductive plate, and the first magnet are sequentially stacked on the inner wall along the first direction, and projections of the second magnet, the first magnetically conductive plate, and the first magnet along the first direction completely overlap.

5. The vibration motor as described in claim 1, wherein the first magnet is a three-segment magnetization structure, the first magnet has a first magnetization region, a second magnetization region, and a third magnetization region sequentially arranged along the vibrating direction; and the first magnetization region and the third magnetization region have a same magnetization direction, and are both magnetized along a direction perpendicular to the vibrating direction.

6. The vibration motor as described in claim 1, wherein the first magnet is a three-segment magnetization structure, the first magnet has a first magnetization region, a second magnetization region, and a third magnetization region sequentially arranged along the vibrating direction; and the first magnetization region and the third magnetization region have opposite magnetization directions and are both magnetized along the vibrating direction.

7. The vibration motor as described in claim 5, wherein the magnet assembly comprises two first magnet assemblies, the two first magnet assemblies are respectively arranged at two sides of the coil assembly along the first direction, and the first magnets of the two first magnet assemblies have poles of a same polarity opposite to each other.

8. The vibration motor as described in claim 3, wherein projections of the third magnet, the second magnetically conductive plate, and the fourth magnet along the vibrating direction completely overlap.

9. The vibration motor as described in claim 8, wherein the third magnet and the fourth magnet have a same magnetization direction, and are both magnetized along the vibrating direction.

10. The vibration motor as described in claim 9, wherein the magnet assembly comprises two second magnet assemblies, the two second magnet assemblies are respectively arranged at two sides of the coil assembly along the vibrating direction, and the third magnets of the two second magnet assemblies have poles of a same polarity opposite to each other.
